(19) United States
(12) Patent Application Publication
(10) Pub. No.: US 2020/0077182 A1
(43) Pub. Date: Mar. 5, 2020

(54) SYSTEM AND METHOD FOR DETECTING SOUND IN VEHICLE

(71) Applicants: HYUNDAI MOTOR COMPANY, Seoul (KR); KIA MOTORS CORPORATION, Seoul (KR)

(72) Inventors: Michael SCHREIBER, Frankfurt Am Main (DE); Bernd-Uwe PLATZKE, Frankfurt Am Main (DE); Christopher MILLS, Frankfurt Am Main (DE)

(21) Appl. No.: 16/191,711

(22) Filed: Nov. 15, 2018

(30) Foreign Application Priority Data
Aug. 31, 2018 (DE) 10 2018 214 848.1

(51) Int. Cl. H04R 1/46; H04R 19/04

(52) U.S. Cl. CPC H04R 1/46; H04R 2499/13; H04R 19/04

(57) ABSTRACT

A system for detecting sound in a vehicle comprises: at least one structure-borne sensor disposed on at least one contact surface, wherein the at least one structure-borne sensor is configured to be contactable with a transmission medium, and the at least one contact surface is separately arranged from transmission medium which transfers sound inside the vehicle.

### CROSS-REFERENCE TO RELATED APPLICATION

This application claims priority to and the benefit of German Patent Application No. 102018214848.1 filed in the German Intellectual Property Office on Aug. 31, 2018, the entire contents of which are incorporated herein by reference.

### TECHNICAL FIELD

The present disclosure relates to a system and a method for detecting sound, more particularly, to a system and a method for detecting sound during operation of a vehicle.

### BACKGROUND

Communication, such as telephone call, when driving a vehicle can be influenced by disturbing noises. The disturbing noises may be based on different factors and typically influences voice, speech, and/or call quality during the telephone call or communication. In particular, the disturbing factors such as engine noise, air stream, noise by occupants or passengers, noise by wiper system, etc. may influence hands-free telephone communication, for example, connection via Bluetooth in combination with in-vehicle or vehicle microphone. Thus, the disturbing factors influence the voice, speech, and/or call quality such that the voice, speech, and/or call quality itself is unpleasant for participants of the telephone call.

Accordingly, efforts have been being made to improve the call quality and/or voice recording quality by repositioning of the microphone or vehicle microphone. For instance, a microphone can be placed near a seatbelt to reduce a distance between a driver and the microphone.

Therefore, there is a high interest in providing a system for interference and disturbance free voice and/or sound detection to improve communication and/or telephone quality.

In other words, there is a high interest in avoiding or reducing disturbing and/or surrounding noises in a vehicle, in particular, during a driving mode.

Consequently, there is a need to further improve the signal-to-noise ratio, in particular, during the driving mode of a vehicle.

### SUMMARY

The present disclosure relates to a system and a method for detecting sound

Under the term “sound and/or voice detection” also “sound and/or voice recognition” shall be understood. It is conceivable that functionalities of a vehicle may be preceded by voice command by the driver or vehicle owner. Therefore, the detection and the recognition of the sound and/or voice quality shall be understood herewith.

In the following the term “signal-to-noise ratio” is abbreviated SNR. Here, the SNR is a measure that compares a level of a detected signal to a level of background or disturbing noises.

Under the term “structure-borne sensor” also the term “structure-borne sound sensor” shall be understood.

The SNR detected by a structure-borne sensor may be improved than detected with conventional communication devices, such as a microphone. In other words, the sound, voice, speech, and/or call quality detected by the structure-borne sensor is better than that detected by the conventional communication devices.

In the following under “sound and/or voice” also “speech and/or call” shall be understood.

Under the term “sound and/or voice detection” also “sound and/or voice recognition” shall be understood.

According to an exemplary embodiment of the present disclosure, a system for detecting sound in a vehicle comprises: at least one structure-borne sensor arranged on at least one contact surface inside the vehicle, wherein the at least one structure-borne sensor is configured to be contactable with a transmission medium, and the at least on contact surface is separately arranged from the transmission medium.

The at least one structure-borne sensor may be based on an acceleration sensor which detects vibrations and pressure, respectively.

The at least one structure-borne sensor may be configured to detect sound and/or vibrations transferred over a human body. Thus, the SNR can be efficiently improved by avoiding or reducing a propagation path between sound and/or voice source and detection device, here the at least one structure-borne sensor.

Sound is a vibration that typically propagates as an audible wave of pressure, through a transmission medium such as a gas, liquid or solid, here the human body.

The transmission medium may be the human body. Thus, the at least one structure-borne sensor and the transmission medium may be in direct contact with the human body. It is conceivable that the at least one structure-borne sensor may be located and/or attached directly on the human body, wherein the signal from the at least one structure-borne sensor may be transmitted by using wireless data transfer, such as Bluetooth. Thus, the system can provide an improved SNR.

The transmission medium may be a fabric and/or woven fabric, wherein the fabric and/or woven fabric may be at least partially in direct contact with the human body. Alternatively the fabric and/or woven fabric can be arranged between the human body and the at least one structure-borne sensor, wherein the at least one structure-borne sensor may be arranged on the at least one contact surface. For example the fabric and/or woven fabric may be provided as a T-shirt and/or sweatshirt, for example. Surprisingly it was found out that the detected SNR may be comparable or better than the SNR detected by the conventional communication devices using air as the transmission medium.

A plurality of the structure-borne sensors may be arranged in an array of the at least one contact surface. Thus, the plurality of structure-borne sensors can be easily arranged on predetermined locations of the at least one contact surface.

The array may be arranged or may be a part of a backrest or a safety belt of a vehicle. The plurality of structure-borne sensor can be in particular arranged in the shoulder area of the backrest or safety belt, for example. Thus, the SNR can be efficiently improved by optimized arrangement of the structure-borne sensors.

The at least one structure-borne sensor may be arranged on a shoulder area of the backrest. The shoulder area can be part of the backrest of a vehicle seat.

The system may further comprise a transducer, wherein the detected sound and/or voice from the transducer and the at least on structure-borne sensor may be compared, such that a signal having a better SNR may be transmittable either by at least one structure-borne sensor or the transducer. Thus, the system can provide an optimized SNR.

In other words, the system may be able to compare the SNR ratios detected by the at least one structure-borne sensor or the transducer, wherein the system with the better SNR can be used or transmitted to a dialogue partner during driving mode, for example.

The transducer may be a microphone. For example, the at least one structure-borne sensor can be arranged on the shoulder area of the backrest, a seat or the shoulder area on the safety belt. The microphone can be arranged on the car fittings or in an area near the windscreen of the vehicle. In other words, the microphone can be arranged in front of the driver. Thus, the SNR can be efficiently compared in dependence of the transmission medium.

The transducer may be a microphone and wherein the microphone is located on an opposite side of the at least one structure-borne sensor of the vehicle. Thus, the SNR can be efficiently compared in dependence of the transmission medium.

According to another exemplary embodiment of the present disclosure, a method for detecting sound in a vehicle comprises: detecting the sound via the at least one structure-borne sensor disposed on at least one contact surface inside the vehicle, wherein the sound is transferred from a transmission medium.

The sound detection may be simultaneously conducted via a transducer and the better signal-to-noise ratio based on a comparison of the signal-to-noise ratio detected by the at least one structure-borne sensor and the signal-to-noise ratio detected by the transducer may be used.

The features disclosed for the system are also disclosed for the method and vice versa.

### BRIEF DESCRIPTION OF THE DRAWINGS

For a more complete understanding and advantages thereof, reference is now made to the following description taken in conjunction with the accompanying drawings, in which:

FIG. 1 illustrates a system for detecting sound according to an embodiment of the present disclosure;

FIG. 2 illustrates an arrangement of a plurality of structure-borne sensors on a car sheet according to a further embodiment of the present disclosure;

FIG. 3 illustrates the further arrangement of a structure-borne sensor according to a further embodiment of the present disclosure;

FIG. 4 illustrates an arrangement of at least one structure-borne sensor on a back rest and a seating area according to a further embodiment of the present disclosure;

FIG. 5 illustrates two signal-to-noise ratios (SNRs) detected by a transducer and the structure-borne sensor according to a further embodiment of the present disclosure;

FIG. 6 illustrates a flow diagram for a method for detecting sound according to a further embodiment of the present disclosure;

FIG. 7 illustrates a further flow diagram for a method for detecting sound according to a further embodiment of the present disclosure;

FIG. 8 illustrates an exemplary SNR detected on position P1 of the backrest as shown in connection with FIG. 2;

FIGS. 9A-9F illustrate six SNRs detected on six different positions P1 to P6 as illustrated in connection with FIGS. 2 and 3;

FIGS. 10A and 10B illustrate a comparison between a SNR detected by a microphone and a SNR detected by a structure-borne sensor during speaking of one person and missing background noise;

FIGS. 11A and 11B illustrate a comparison between a SNR detected by a microphone and a SNR detected by a structure-borne sensor during speaking of one person and turning on an engine;

FIGS. 12A and 12B illustrate a comparison between a SNR detected by a microphone and a SNR detected by a structure-borne sensor during speaking of one person, turning on an engine and turning on a radio on medium sound level;

FIGS. 13A and 13B illustrate a comparison between a SNR detected by a microphone and a SNR detected by a structure-borne sensor during speaking of two persons and turning off an engine;

FIGS. 14A and 14B illustrate a comparison between a SNR detected by a microphone and a SNR detected by a structure-borne sensor during speaking of two persons, turning on an engine and turning off a radio; and

FIGS. 15A and 15B illustrate a comparison between a SNR detected by a microphone and a SNR detected by a structure-borne sensor during speaking of two persons, turning on an engine and turning on a radio.

Unless indicated otherwise, like reference numbers or signs to the figures indicate like elements.

### DETAILED DESCRIPTIONS

In the following the term “signal-to-noise ratio” is abbreviated SNR. Here, the SNR is a measure that compares the level of a detected signal to a level of background or disturbing noises.

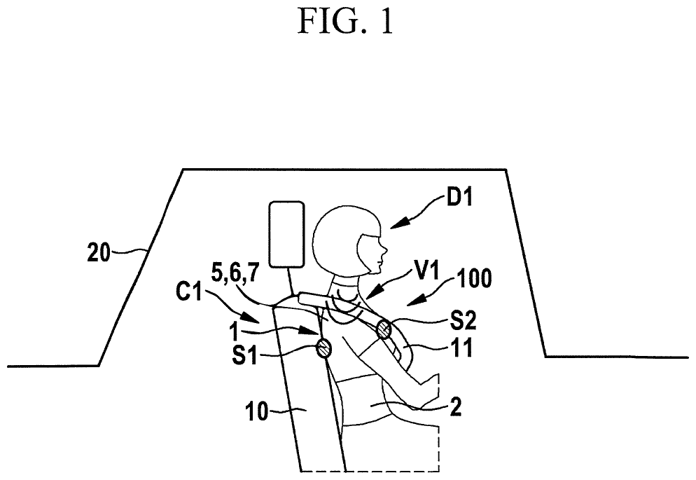

FIG. 1 illustrates a system for detecting sound according to an embodiment of the present disclosure.

FIG. 1 shows a side view of a car seat C1 of a vehicle 20 with a backrest 10. A driver D1 sits on the car seat C1 and is protected by a seat belt 11.

A system 100 for detecting sound according to an exemplary embodiment of the present disclosure as illustrated in FIG. 1 comprises at least one structure-borne sensor S1, S2 arranged on at least one contact surface 1, such that the at least one structure-borne sensor S1, S2 is configured to be contactable with a transmission medium 5, and wherein the transmission medium 5 is arranged opposite to the at least one contact surface 1.

In FIG. 1 the at least one contact surface 1 can be at least part of the backrest 10 and the safety belt 11. The transmission medium 5 can be a fabric and/or woven fabric 6, such as a T-shirt 7, is arranged opposite to the at least one contact surface 1. The at least one structure-borne sensor S1, S2 is arranged between the at least one contact surface 1 and the transmission medium 5. Therefore, a propagation path can be efficiently bridged and reduced.

The at least one structure-borne sensor S1, S2 may be an acceleration sensor that is configured to detect vibrations V1 and/or pressure.

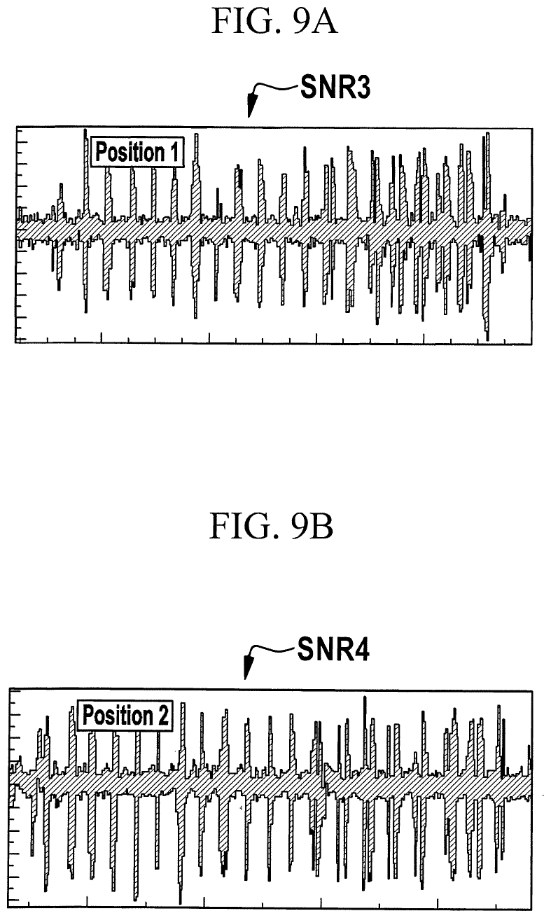

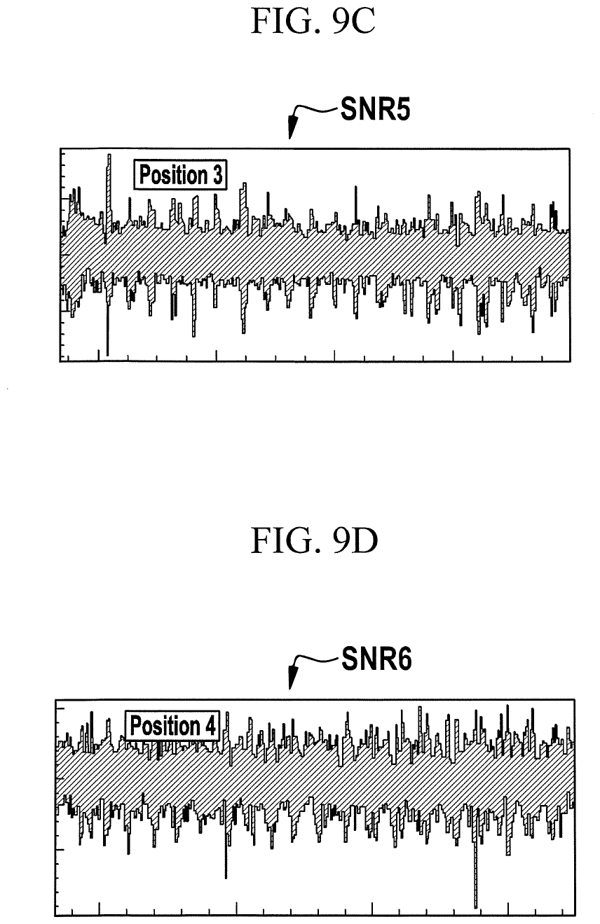

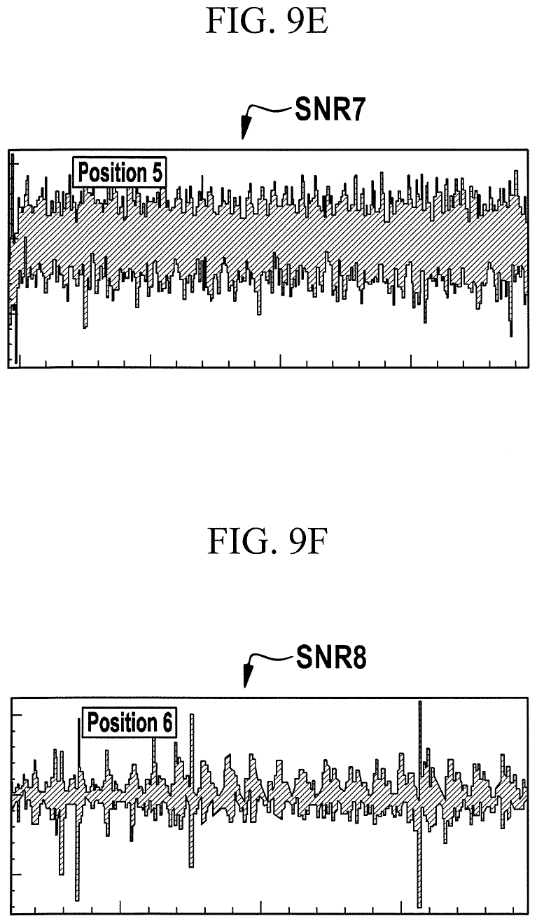

The SNR detected by the at least one structure-borne sensor S1, S2 can be more clearly detected than when using conventional communication devices, such as a microphone M1 (see FIGS. 9A to 9F).

In other words, the improved sound, voice, speech and/or call quality can be detected, compared to when using the conventional communication devices.

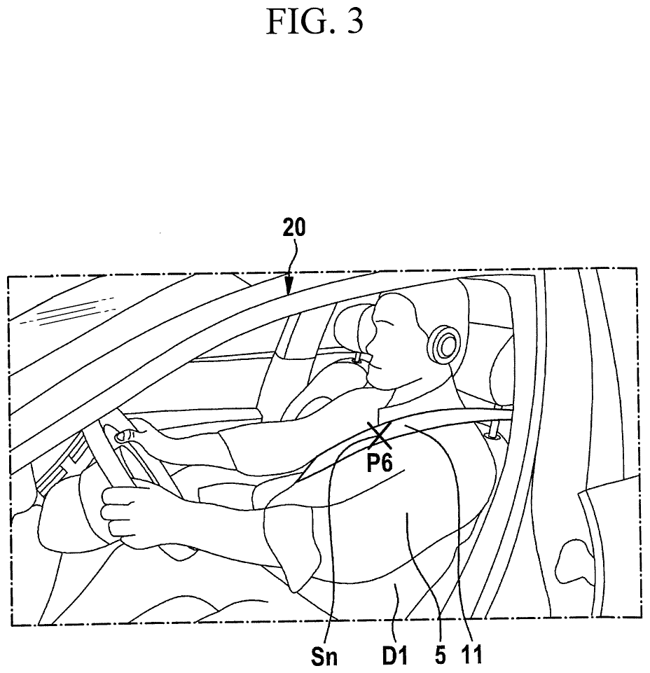

Alternatively, the at least one structure-borne sensor Sn, S1, S2 and the transmission medium 5 may be in direct contact with a human body 2 (see FIG. 3). It is conceivable that the at least one structure-borne sensor Sn, S1, S2 may be located and/or attached directly on the human body 2, wherein the signal from the at least one structure-borne sensor Sn, S1, S2 may be transmitted by using wireless data transfer, such as Bluetooth. Thus, the system 100 may provide an improved SNR.

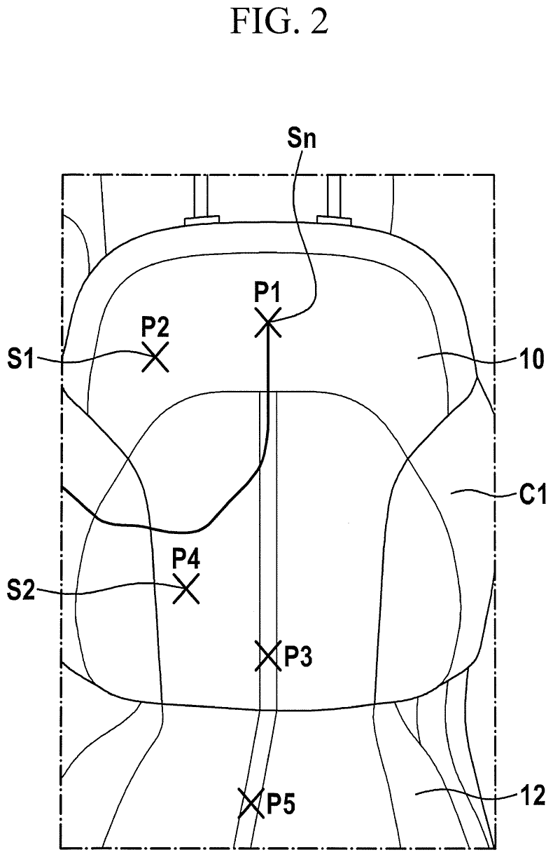

FIG. 2 illustrates an arrangement of a plurality of structure-borne sensors on the car seat C1 according to a further embodiment of the present disclosure.

In FIG. 2 the at least one structure-borne sensor Sn, S1, S2 or the plurality of structure-borne sensors Sn, S1, S2 are arranged and/or are at least partially integrated in the backrest 10 or a seat 12 of the car seat C1.

The corresponding SNRs detected on the positions P1 to P5 will be explained in connection with the corresponding SNRs of FIGS. 9A to 9E.

FIG. 3 illustrates a further arrangement of a structure-borne sensor according to a further embodiment of the present disclosure.

In FIG. 3 the at least one structure-borne sensor Sn, S1, S2 is arranged on a shoulder area of the seat belt 11 of the vehicle 20. The seat belt 11 may press the structure-borne sensor Sn against the transmission medium 5, for example, a shirt of the driver D1.

The corresponding SNR detected on the position P6 will be explained in connection with the corresponding SNR of FIG. 9F.

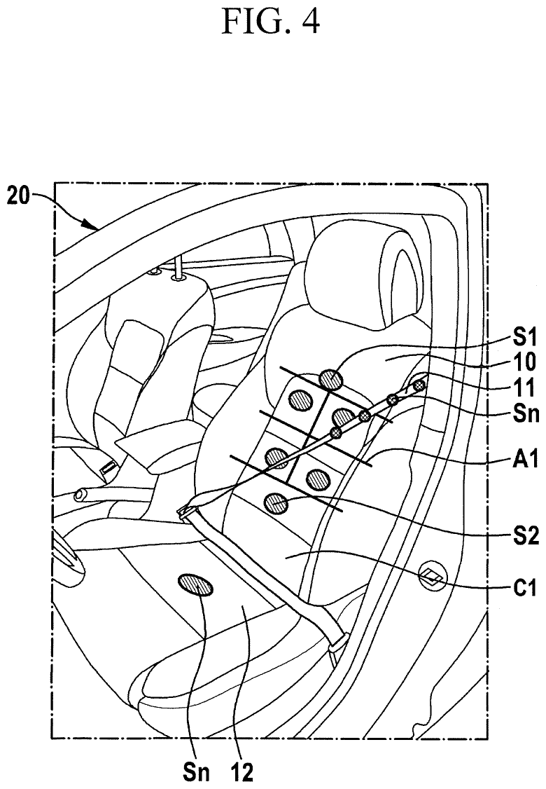

FIG. 4 illustrates an arrangement of at least one structure-borne sensor on a back rest and a seat of a car seat according to a further embodiment of the present disclosure.

FIG. 4 illustrates an array A1 arranged on the backrest 10 of the car seat C1 of the vehicle 20. The at least one structure-borne sensor Sn, S1, S2 are arranged on the array A1 of the backrest 10, the seat 12, and on the shoulder area of the safety belt 11. Therefore, the at least one structure-borne sensor Sn, S1, S2 can be easily arranged on predetermined positions.

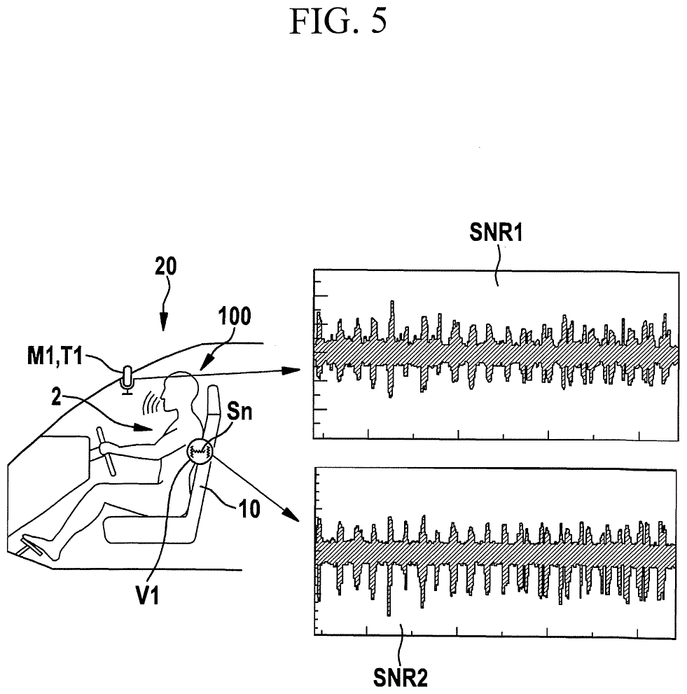

FIG. 5 illustrates two SNRs detected by a transducer and the structure-borne sensor of a system according to a further embodiment of the present disclosure.

FIG. 5 shows the system 100 of the vehicle 20 which further comprises a transducer T1, and the detected sound and/or voice from the transducer T1 and the at least one structure-borne sensor Sn are compared, such that a better signal-to-noise ratio is transmittable either by the at least one structure-borne sensor Sn or the transducer T1. The transducer T1 can be in particular a microphone M1 which can be arranged in an area near a windscreen of the vehicle 20.

In the present disclosure, the system 100 may further include a processor such as an electronic control unit (ECU) or central processing unit (CPU) to perform various functions such as comparing the detected sound and/or voice from the transducer T1 and the at least one structure-borne sensor Sn.

The SNR2 detected by the structure-borne sensor Sn near the shoulder area of the backrest 10 delivers an appropriate SNR2 which is similar or better than SNR1, wherein SNR1 has been detected by the microphone M1. That is, based on a human body contact, a voice of the driver D1 can be detected and/or recorded via structural excitation of the human body 2. Thus, the sound and/or voice detection is in particular not influenced by other occupants and/or background noises. Consequently, an improved sound and/or voice quality may be obtained based on an optimized propagation path.

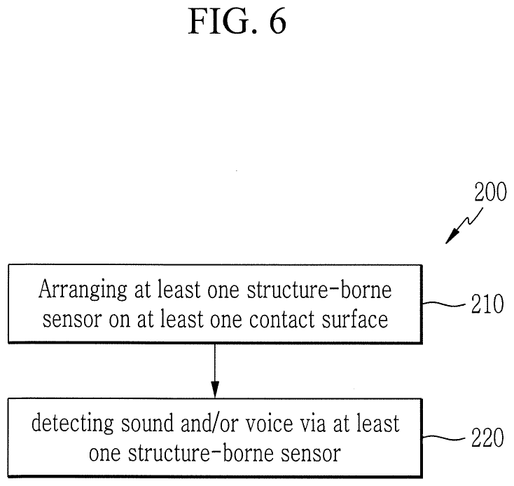

FIG. 6 illustrates a flow diagram for a method for detecting sound according to a further embodiment of the present disclosure.

The flow diagram of a method 200 for detecting sound comprises steps 210, 220.

In step 210, the at least one structure-borne sensor Sn, S1, S2 is arranged on at least one contact surface 1.

In step 220, the sound and/or voice via the at least one structure-borne sensor Sn, S1, S2 is detected, wherein the detection of the sound and/or the voice via the at least one structure-borne sensor Sn, S1, S2 is conducted through a transmission medium 5.

Alternatively, the sound and/or voice detection is simultaneously conducted using the transducer T1 and a better SNR ratio based on a comparison of the signal-to-noise ratio detected by the at least one structure-borne sensor Sn, S1, S2 and the SNR ratio detected by the transducer T1 is transmitted to a receiver or conversation partner (not shown).

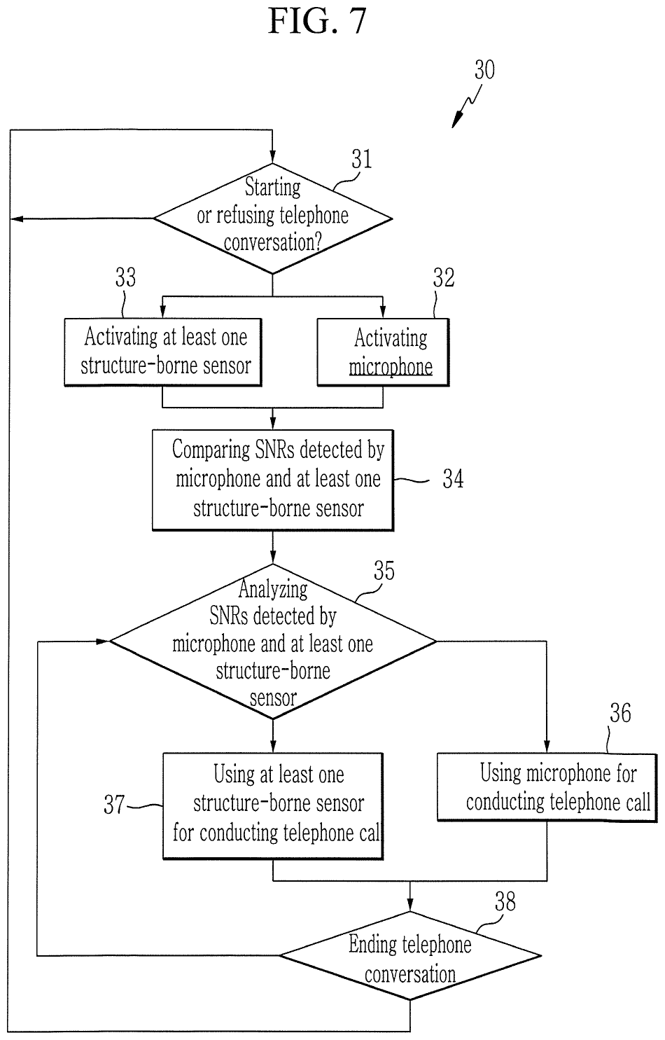

FIG. 7 illustrates a further flow diagram for a method for detecting sound according to a further embodiment of the present disclosure.

FIG. 7 is a more detailed flow diagram based on the method illustrated in FIG. 6 with respect to a telephone conversation in the vehicle 20.

The flow diagram of the detailed method 30 of FIG. 7 comprises steps 31 to 38.

In step 31, the telephone conversation can be started or refused.

In case the telephone is accepted, steps 32, 33 may occur, wherein the microphone M1 and the at least one structure-borne sensor Sn, S1, S2, are simultaneously activated.

In step 34, the detected SNR of the microphone M1 and the at least one structure-borne sensor Sn, S1, S2 are compared to each other.

In step 35, the detected SNR of the solid-bore sensor Sn, S1, S2 is analyzed under consideration of the detected or recorded SNR of the microphone M1. In case the quality of the SNR of the microphone M1 is better than the detected voice and/or sound detected via the at least one structure-borne sensor the microphone M1 is used for conducting the telephone call (see step 36).

When the quality of the detected SNR via the at least one structure-borne sensor Sn, S1, S2 is better than detected via the microphone M1 the at least one structure-borne sensor Sn, S1, S2 is used for conducting the telephone call (see step 37).

The here mentioned comparison between the detected SNR via the microphone M1 and the at least one structure-borne sensor Sn, S1, S2 are conducted in loops during the whole telephone conversation since circumstances during the telephone can be changed easily, such as disturbing noise like raining or increased engine noise during acceleration. It is further conceivable that the here described system may deliver better SNR in case of talking passengers in the vehicle, whereby the talking passengers shall not influence, participate and/or disturb the telephone conversation.

After ending the telephone conversation in step 38, the method 30 returns to step 31.

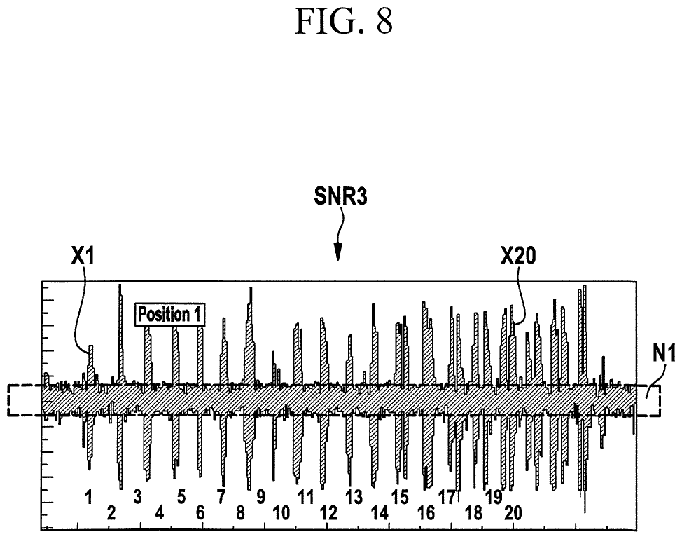

FIG. 8 illustrates an exemplary SNR detected on position P1 as shown in FIG. 2.

The SNR has been detected on position P1 which is located in an upper shoulder area of the backrest 10.

The here illustrated SNRs have been measured, detected or recorded in a noise, vibration and harshness laboratory (abbreviated: NVH laboratory).

In FIG. 8 the dotted box N1 illustrates a noise level. The signals X1 to X20 indicate a counting from 1 to 20 of the driver D1 and test-person, respectively.

FIG. 8 indicates the signals detected when the test-person counted from 1 to 20.

The noise level may be optimized by using different or various sensors/structure-borne sensors or Fast Fourier Transformation (FFT) based analysis to identify frequency bandwidths that can be eliminated by filters, for example low pass filter.

FIGS. 9A to 9F illustrate six SNRs detected on six different positions P1 to P6 as illustrated in connection with FIGS. 2 and 3.

FIGS. 9A to 9F illustrate six SNRs (SNR 3 to SNR 8) which were detected at different positions P1 to P6 (see FIGS. 2 and 3). It can be clearly seen that at different position differences in the SNR can be demonstrated. Best results were obtained on positions P1 and P2 which were arranged on an upper backrest area 10 (see FIG. 2). In other words, the noise level is at the positions P1 and P2 comparatively low. Therefore, on positions P1 and P2 the SNR3 and SNR4 shows good SNRs.

In contrast SNRs at the positions P3, P4 and P5 show a high noise level. The SNR detected at position P6 which corresponds to the shoulder area of the seat belt 11 shows a quite promising result which can be in particular further optimized by improvement of corresponding raw data.

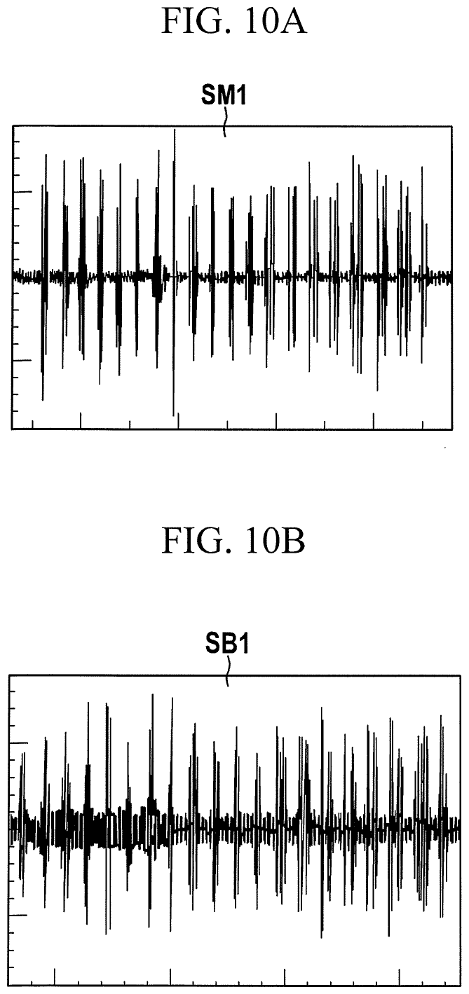

FIGS. 10A and 10B illustrate a comparison between a SNR detected by a microphone and a SNR detected by a structure-borne sensor during speaking of one person and missing background noise.

SM1 detected by the microphone M1 shows under the circumstance that one person is speaking and missing background noise slightly better results than SB1 detected via the structure-borne sensor. In other words, under the here mentioned condition the method as described in connection with FIG. 7 would choose the microphone as communication device.

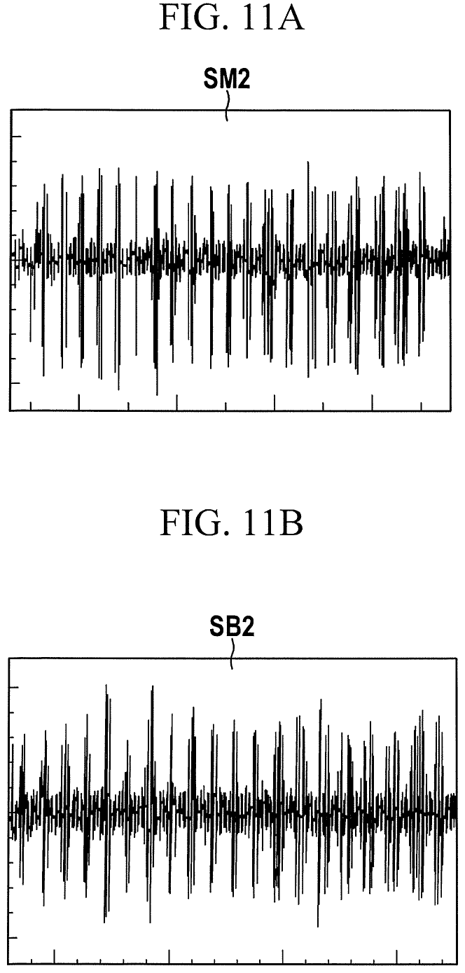

FIGS. 11A and 11B illustrate a comparison between a SNR detected by a microphone and a SNR detected by a structure-borne sensor during speaking of one person and turning on an engine.

As can be seen in FIG. 11B SB2 shows a signal having a better SNR than the corresponding SNR, that is, SM2 detected by the microphone M1. In other words, already when the engine of the vehicle 20 may be turned on the at least one structure-borne sensor at the positions P1 and P2 delivers at least comparable or even better SNR.

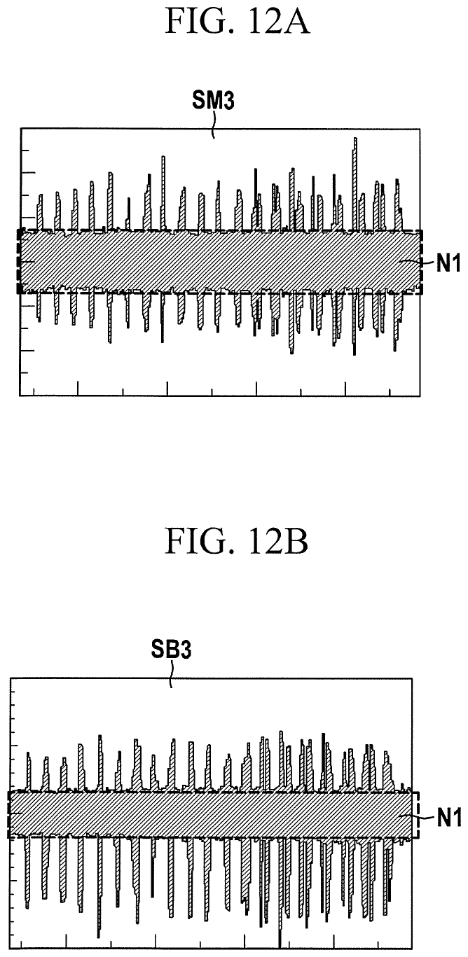

FIGS. 12A and 12B illustrate a comparison between a SNR detected by a microphone and a SNR detected by a structure-borne sensor during speaking of one person, turning on an engine and turning on a radio on medium sound level.

SB3 shows in comparison to the detected SM3 via the microphone M1 better SNR. It can be clearly seen that the noise level N1 of the SM3 is higher than in the SB3. That is, the SNR is comparatively better when detected by the at least one structure-borne sensor during speaking of the one person, turning on the engine and turning on the radio on medium sound level.

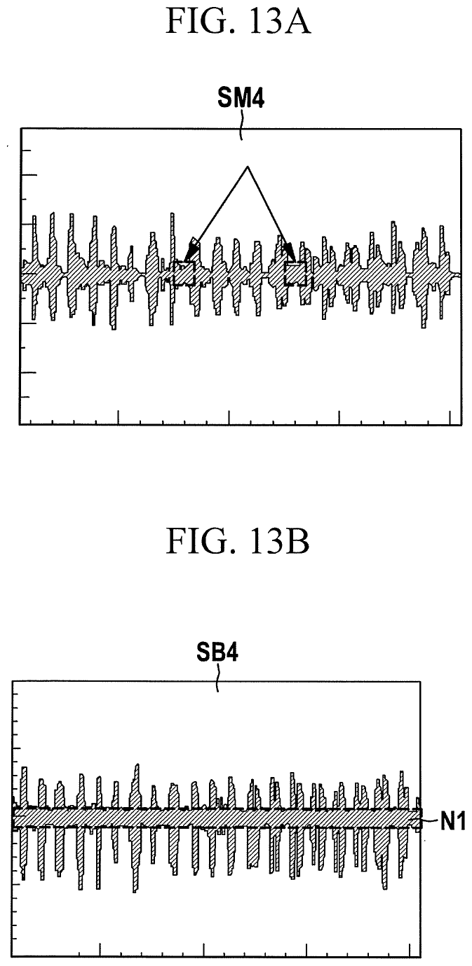

FIGS. 13A and 13B illustrate a comparison between a SNR detected by a microphone and the SNR detected by a structure-borne sensor during speaking of two persons and turning off an engine.

FIGS. 13A and 13B also show a better SNR when using the at least structure-borne sensor the noise level (lower and homogeneous noise level N1). In Addition, SB4 doesn't comprise the voice of a second person as can be identified in the SM4 (indicated by arrows). That is, the structure-borne sensor may detect the vibrations of the driver D1 which is free of the voice of the second person.

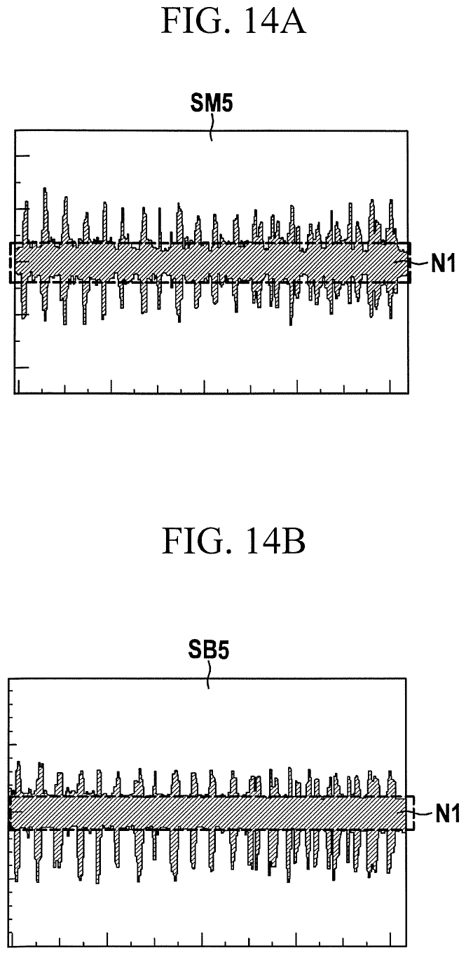

FIGS. 14A and 14B illustrate a comparison between a SNR detected by microphone and a SNR detected by a structure-borne sensor during speaking of two persons, turning on an engine and turning off a radio.

Here, in connection with FIGS. 14A and 14B, SB5 shows a signal having a better SNR since the noise level N1 is nearly constant and lower in comparison to the SM5 detected by the microphone. In Addition, the SB5 doesn't comprise the voice of the second person.

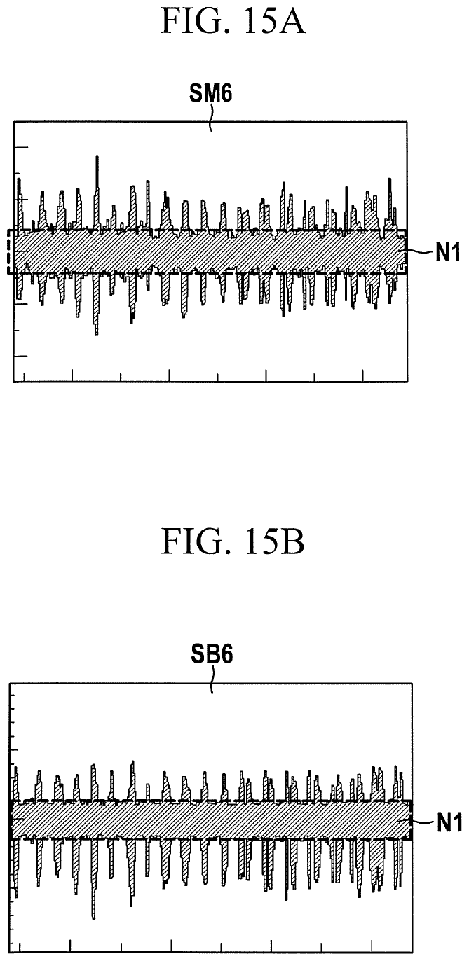

FIGS. 15A and 15B illustrate a comparison between a SNR detected by microphone and a SNR detected by a structure-borne sensor during speaking of two persons, turning on an engine and turning on a radio.

The results shown in FIGS. 15A and 15B are comparable to the SNRs shown in connection with FIGS. 14A and 14B.

In other words, using the here described system 100 delivers overall competitive and better results under the here explained circumstances.

It is clear from the context that by using different structure-borne sensors the here shown results can be easily optimized. Further, the arrangement of the at least one structure-borne sensor can be further optimized. Using Fast Fourier Transformation (FFT) for selected signal of the structure-borne sensor to identify frequency bandwidths of noise and using corresponding filter to reduce car-induced noise can further improve the here shown SB1 to SB6.

It is clear from the context of the present disclosure that the here described system can be also adapted to other interior devices where disturbing noises may occur.

Although the here afore-mentioned system has been described in connection with vehicles, respectively, for a person skilled in the art it is clearly and unambiguously understood that the here described system can be applied to various communications systems.

Generally, this application is intended to cover any adaptations or variations of the specific embodiments discussed herein.

1. A system for detecting sound in a vehicle comprising:
at least one structure-borne sensor disposed on at least one contact surface inside the vehicle; and
a transducer detecting sound in the vehicle,
wherein the at least one structure-borne sensor is configured to contact a transmission medium which transfers sound inside the vehicle,
wherein the at least one contact surface is separately arranged from the transmission medium, and
wherein the detected sound from the transducer and the detected sound from the at least one structure-borne sensor are compared, such that one among the detected sound from the transducer and the detected sound from the at least one structure-borne sensor having a lower noise level is transmitted to a receiver of the vehicle.

2. The system according to claim 1, wherein the at least one structure-borne sensor is configured to detect at least one of sound or vibration transferred from the transmission medium.

3. The system according to claim 1, wherein the transmission medium is a human body.

4. The system according to claim 1, wherein the transmission medium is a fabric,
wherein the fabric is in contact with a human'body.

5. The system according to claim 1, wherein a plurality of structure-borne sensors are disposed on a plurality of contact surfaces, respectively.

6. The system according to claim 5, wherein the plurality of structure-borne sensors are disposed on at least one of a backrest or a seat belt of a vehicle seat.

7. The system according to claim 5, wherein the at least one structure-borne sensor is disposed on a shoulder area of a backrest of a vehicle seat.

8. The system according to claim 6, wherein the plurality of structure-borne sensors are disposed on a shoulder area of the backrest.

9. (canceled)

10. The system according to claim 2, wherein the detected sound having the lower noise level is transmitted to the receiver via Bluetooth connection.

11. The system according to claim 9, wherein the transducer is a microphone.

12. The system according to claim 9, further comprising a processor configured to compare the detected sound from the transducer and the detected sound from the at least one structure-borne sensor.

13. A method for detecting sound in a vehicle comprising:
detecting a sound via at least one structure-borne sensor disposed on at least one contact surface inside the vehicle;
detecting sound via a transducer; and
comparing the sound detected by the at least one structure-borne sensor and the sound detected by the transducer,
wherein the sound is transferred from a transmission medium, and
wherein a signal having a lower noise level based on a comparison result is transmitted to a receiver of the vehicle.

14. (canceled)
